(19) United States
(12) Patent Application Publication
(10) Pub. No.: US 2007/0123296 A1
(43) Pub. Date: May 31, 2007

(54) TELECOMMUNICATION SYSTEM

(75) Inventor: Li-Feng Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/534,740

(22) Filed: Sep. 25, 2006

Related U.S. Application Data
(60) Provisional application No. 60/725,384, filed on Oct. 11, 2005.

(51) Int. Cl. H04M 1/00

(52) U.S. Cl. 455/550.1

(57) ABSTRACT

A telecommunication system. The telecommunication system comprises a telecommunication apparatus and an audio accessory attached thereto. The audio accessory comprises an accessory interface and an accessory controller. The accessory controller controls operation of the audio accessory according to connection status of the audio interface. The telecommunication apparatus comprises an apparatus interface and an apparatus controller. The apparatus interface is configured to physically connect the telecommunication apparatus to the accessory interface of the audio accessory. The apparatus controller controls operation of the telecommunication apparatus according to connection status of the apparatus interface.

### CROSS REFERENCE TO RELATED APPLICATIONS

This application claims priority of U.S. Provisional Patent Application Ser. No. 60/725,384, filed Oct. 11, 2005, entitled “Telecommunication system”. The contents of the provisional applications are hereby incorporated by reference.

### BACKGROUND

The invention relates to a telecommunication system and in particular to a telecommunication system comprising a mobile phone and a hands-free headset.

The type of devices capable of telecommunication has grown rapidly. Examples of commercially available telecommunication devices comprise IP soft phones, mobile phones, and Wi-Fi phones. The appearance of some telecommunication devices are completely different from conventional telephones, as is the way they are used. For example, an IP soft phone is implemented by software installed on a computer. When using an IP soft phone, i.e. when using a computer installed with communication software, to communicate with other IP soft phones, an earphone/speaker/microphone is used to transmit and receive vocal signals. Hands-free units, such as wired and cordless headsets, are also used with the IF soft phone.

Conventionally, there are two ways to operate a wireless headset.

For a wireless headset which is powered on by a default, the wireless headset is pre-connected and paired with a mobile phone. A bidirectional channel is thus established. The headset can be activated when an incoming call is received, and used to control mobile phone operation via a mechanism, such as a voice-activated-dialing mechanism. This always-on operation method enables a quick response of the wireless headset. A start-up time of a wireless headset is not required. The wireless headset, however, consumes power in standby mode when waiting for a call. The limited power of the wireless headset is a disadvantage for always-on operation method.

For a wireless headset operating in a required-power-on operating method, it is powered-off when not in use, and powered on when required. In the required-powered-on operation method, battery life of the wireless headset can be maximized. When the wireless headset is powered-on by requirement, additional operations and time are required for a pairing procedure to establish a communication connection between the mobile phone and the wireless headset.

### SUMMARY

The present invention provides a telecommunication system. The telecommunication system comprises a telecommunication apparatus and an audio accessory attached thereto. The audio accessory comprises an accessory interface and an accessory controller. The accessory controller controls operation of the audio accessory according to the connection status of the audio interface. The telecommunication apparatus comprises an apparatus interface and an apparatus controller. The apparatus interface is configured to physically connect the telecommunication apparatus to the accessory interface of the audio accessory. The apparatus controller controls operation of the telecommunication apparatus according to the connection status of the apparatus interface.

Also provided is telecommunication apparatus operating with a wireless headset. The telecommunication apparatus comprises a metal contact and an apparatus controller. The metal contact is used for electrically connecting to the wireless headset. The apparatus controller controls operation of the telecommunication apparatus according to the connection status of the metal contact.

Also provided is telecommunication apparatus connecting to a headset via a wire. The telecommunication apparatus comprises an actuator, a wire coiling unit and an apparatus controller. The wire coiling unit is used for coiling up the cord when an actuator is activated. The apparatus controller controls operation of the telecommunication apparatus according to the operation status of the wire coiling unit.

Also provided is a method for operating a telecommunication system. The telecommunication system comprises a telecommunication and a wireless headset, wherein the telecommunication apparatus and the wireless headset comprise metal contacts for electrically connecting to each other, respectively. Connection status of the metal contacts is determined, specifying whether the metal contact is connected to each other. Operations of the telecommunication apparatus and the wireless headset are controlled according to connection status of the metal contacts.

Also provided is a method for operating a telecommunication apparatus connecting to a headset via a wire. The telecommunication apparatus comprises an actuator and a wire coiling unit used for coiling up the wire when the actuator is activated. The operation status of the coiling unit is determined. Operation of the telecommunication apparatus is controlled according to the operation status of the wire coiling unit and operation status of the telecommunication apparatus.

### DESCRIPTION OF THE DRAWINGS

The invention can be more fully understood by reading the subsequent detailed description and examples with references made to the accompanying drawings, wherein:

FIGS. 1A and 1B illustrate an embodiment of a mobile phone employing a wireless headset;

FIG. 2 shows a schematic view of an embodiment of a mobile phone and wireless headset attached thereto;

FIGS. 3A and 3B show flowcharts the operations of a mobile phone and a wireless headset when metal contact detachment is detected;

FIGS. 4A and 4B show flowcharts the operations of a mobile phone and a wireless headset when metal contact attachment is detected;

FIGS. 5A and 5B illustrate an embodiment of a mobile phone employing a wired headset;

FIG. 6 shows a schematic view of an embodiment of a mobile phone and wired headset attached thereto;

FIG. 7 illustrates operations of mobile phone when detecting that the coiled wire is drawn out; and

FIG. 8 illustrates operations of mobile phone when the actuator is activated for coiling up the wire.

### DETAILED DESCRIPTION

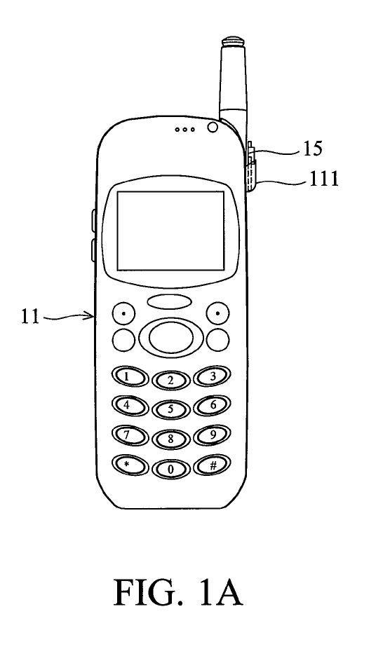

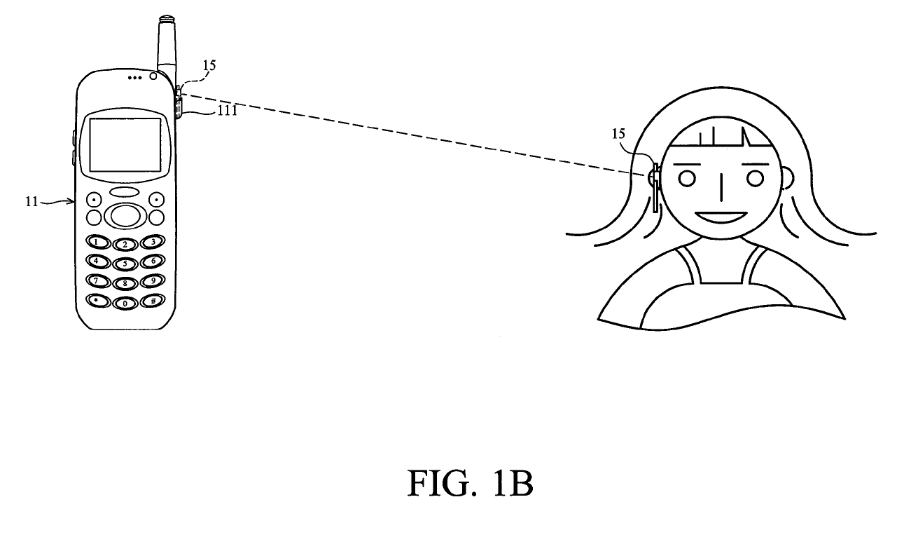

The invention will now be described with reference to FIGS. 1 through 8, which generally relate to a telecommunication system. While some embodiments of the invention are applicable to a mobile phone and a headset attached thereto, it is understood that other telecommunication apparatuses employing hands-free units may be implemented.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

Mobile phones are a prominent example of a telecommunication apparatus equipped with a hands-free unit, such as a headset. Consequently, for the remainder of this disclosure, a mobile phone is referred to, in a non-limiting sense, as an example of a telecommunication apparatus.

FIGS. 1A and 1B illustrate an embodiment of a mobile phone employing a wireless headset. A mobile phone 11 is coupled to a wireless headset 15.

The wireless headset 15 can be attached to mobile phone 11 via a physical mechanism. For example, the wireless headset 15 can be attached to mobile phone 11 via a metal contact, tenon-mortise structure, or other suitable physical mechanism. The mobile phone 11 comprises a holder 111 for holding wireless headset 15.

When wireless headset 15 is detached from mobile phone 11, predetermined operations are triggered, and users can use the wireless headset 15 and mobile phone 11 for communication or other functions.

Detecting whether the wireless headset 15 is detected from mobile phone 11 can be implemented by different method. Detection mechanisms capable of generating a trigger signal when the headset is handled for a specific operation may be implemented. For example, when wireless headset 15 is attached to mobile phone 11 via a metal contact, a trigger signal is generated in response the detachment of the wireless headset 15 and mobile phone 11. When wireless headset 15 is attached to mobile phone 11 via a tenon-mortise structure, a trigger signal is generated in response the detachment of the wireless headset 15 and mobile phone 11. The trigger signal can also be generated by magnetic induction device.

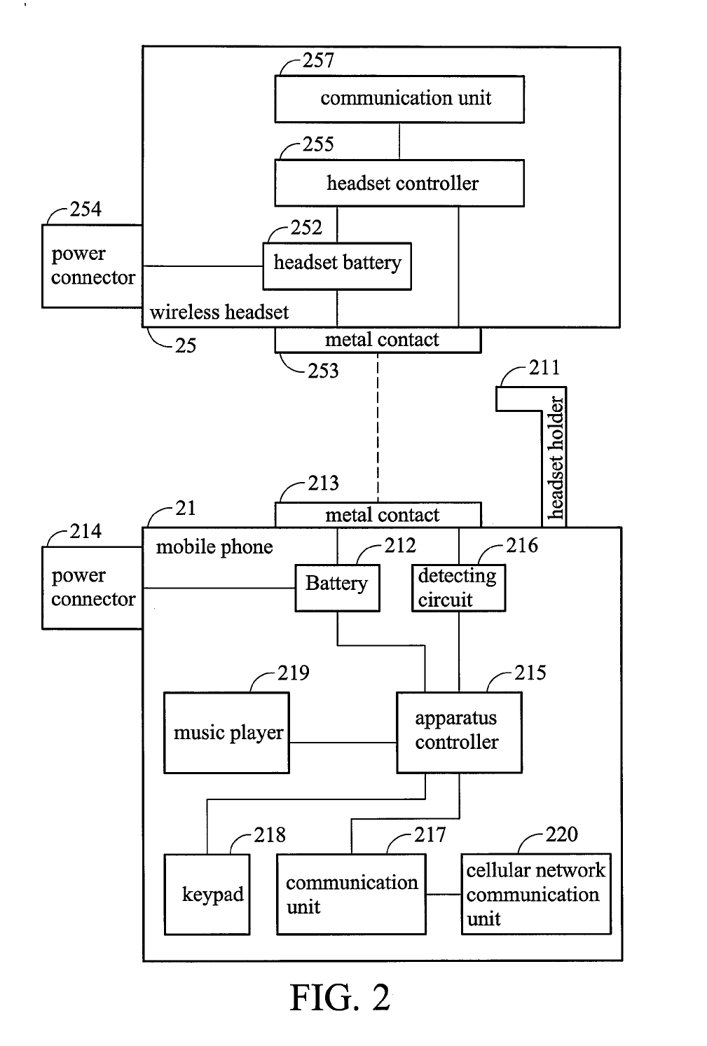

Using metal contact as an example, FIG. 2 shows a schematic view of an embodiment of a mobile phone and wireless headset attached thereto. A mobile phone 21 is provided with a wireless headset 25. The mobile phone 21 comprises headset holder 211, a metal contact 213, a detecting circuit 216, a communication unit 217, a cellular network communication unit 220, a music player 219, a keypad 218, and an apparatus controller 215. The headset holder 211 is used for holding the cordless headset when not in use. The metal contact 213 is used for electrically connecting to the wireless headset when not in use. The detecting circuit 216 is used for detecting whether wireless headset 25 is attached to or detached from mobile phone 21. The communication unit 217 is used to establish a communication connection between the mobile phone 21 and the headset 25, and the cellular network communication unit 220 is used for establishing a cellular communication connection between the mobile phone 21 and a base station (not shown). For example, the headset 25 can be a Bluetooth headset, and communication connection between the mobile phone 21 and the headset 25 is through a Bluetooth network. The Bluetooth is an industrial specification for wireless personal area networks (PANs). Bluetooth provides a way to connect and exchange information between devices like personal digital assistants (PDAs), mobile phones, laptops, PCs, printers and digital cameras via a secure, low-cost, globally available short range radio frequency. The cellular communication connection between the mobile phone 21 and a base station may be a GSM (Global System for Mobile Communications), GPRS (General Packet Radio Service), EDGE (Enhanced Data rates for Global Evolution), CDMA (Code Division Multiple Access) network or similar. The apparatus controller 215 is used for controlling operation of the mobile phone 21 according to the connection status of the metal contact 213. For example, the apparatus controller 215 can control operations of the communication unit 217, the cellular network communication unit 220, the music player 219, the keypad 218, and other functional units equipped in mobile phone 21. The mobile phone 21 also comprises a battery 212 and a power connector 214. Battery 212 supplies electrical power for mobile phone 21, and can be recharged by an external electrical power source via the power connector 214. The wireless headset 25 comprises a metal contact 253, a headset controller 255, and a communication unit 257. The headset controller 255 controls operation of the headset according to the status of the metal contact 253. For example, the headset controller 255 controls the communication unit 257 according to connection status of the metal contact 253. The communication unit 257 is used to establish a communication connection between the mobile phone 21 and the headset 25. The metal contacts 213 and 253 are electrically connected when wireless headset 25 is not in use. The wireless headset 25 also comprises a headset battery 252 and a power connector 254. The headset battery 252 supplies electric power for the wireless headset 25, and can be recharged by an external electrical power source via the power connector 254.

It should be noted that the headset battery 252 can be used as a power source for the battery 212, and the power can be transmitted through the metal contacts 213 and 253 from the headset battery 252 to the battery 212. Similarly, the battery 212 can be used as a power source for headset battery 252, and power can be transmitted through the metal contacts 213 and 253 from the battery 212 to the headset battery 252. Therefore, it can be known that when the metal contact 213 is electrically connected to the metal contact 253 and when the power connector 214/254 is connected to the external electrical power source for recharging, both of the battery 212 and the headset battery 213 can be recharged together by the external electrical power source via the power connector 214/254. That is, when the power connector 214 is connected to the external electrical power source for recharging, the power can be transmitted to the battery 212, and also can be transmitted to the headset battery 252 through the metal contacts 213 and 253.

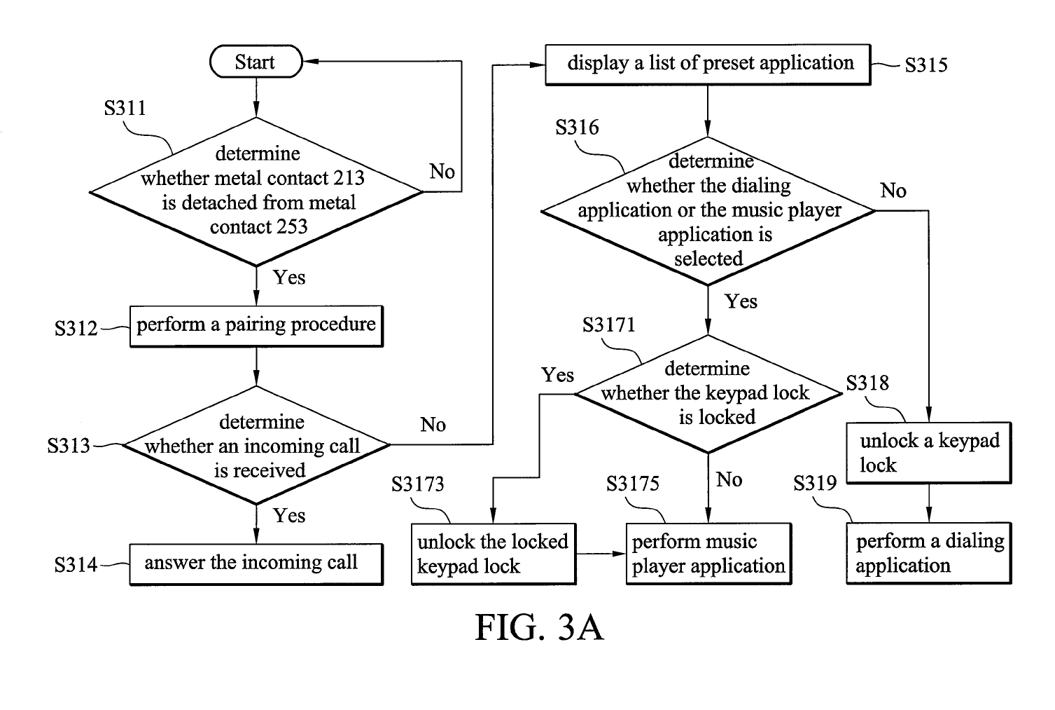

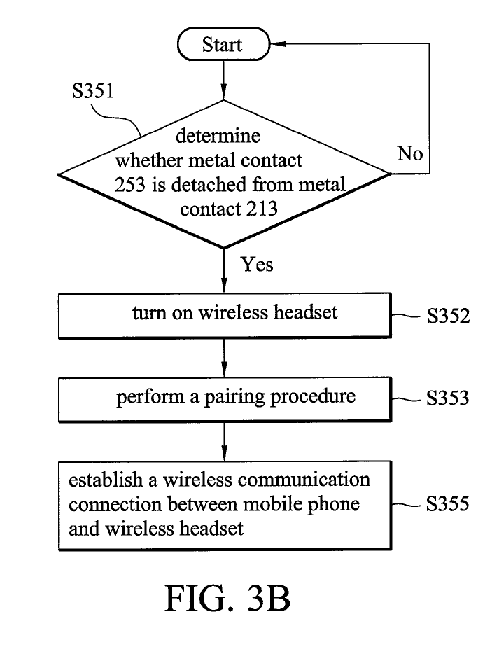

Operations of both the wireless headset 25 and mobile phone 21 can be controlled according to the connection status of the metal contacts 213 and 253. Using FIG. 3A as an example, operations of mobile phone 21 when detecting that metal contact 213 is detached from metal contact 253 are illustrated. In step S311, it is determined whether metal contact 213 is detached from metal contact 253, and if so, the method proceeds to step S312, otherwise the method returns to the beginning. In step S312, a pairing procedure is performed to establish a wireless communication connection, such as a Bluetooth network connection, between mobile phone 21 and wireless headset 35, such as a Bluetooth headset. In step S313, it is determined whether an incoming call is received, and if so, the method proceeds to step S314, otherwise the method proceeds to step S315. In step S314, the incoming call is answered, the cellular network communication connection being established, and the mobile phone 21 is engaged in the call. In step S315, a list of preset application is presented for selection. Here, a list comprising a dialing application and a music player application is presented. In step S316, it is determined whether the dialing application or the music player application is selected. If the dialing application is selected, the method proceeds to step S318, if the music player application is selected, the method proceeds to step S3171. In step S3171, it is determined whether the keypad lock is locked, and if so, the method proceeds to step S3173, otherwise the method proceeds to step S3175. In step S3173, the locked keypad lock is unlocked. In step S3175, the music player application is performed according to instructions input by a user. In step S318, a keypad lock, if any, is unlocked. In step S319, a dialing application is performed according to instructions input by a user.

Using FIG. 3B as an example, operations of wireless headset 25 when detecting that metal contact 213 is detached from metal contact 253 are illustrated. In step S351, it is determined whether metal contact 253 is detached from metal contact 213, and if so, the method proceeds to step S352, otherwise the method returns to the beginning. In step S352, wireless headset 25 is powered on. In step S353, a pairing procedure is performed to establish a wireless communication connection between mobile phone 21 and wireless headset 35. In step S355, the wireless communication connection between mobile phone 21 and wireless headset 35 is established.

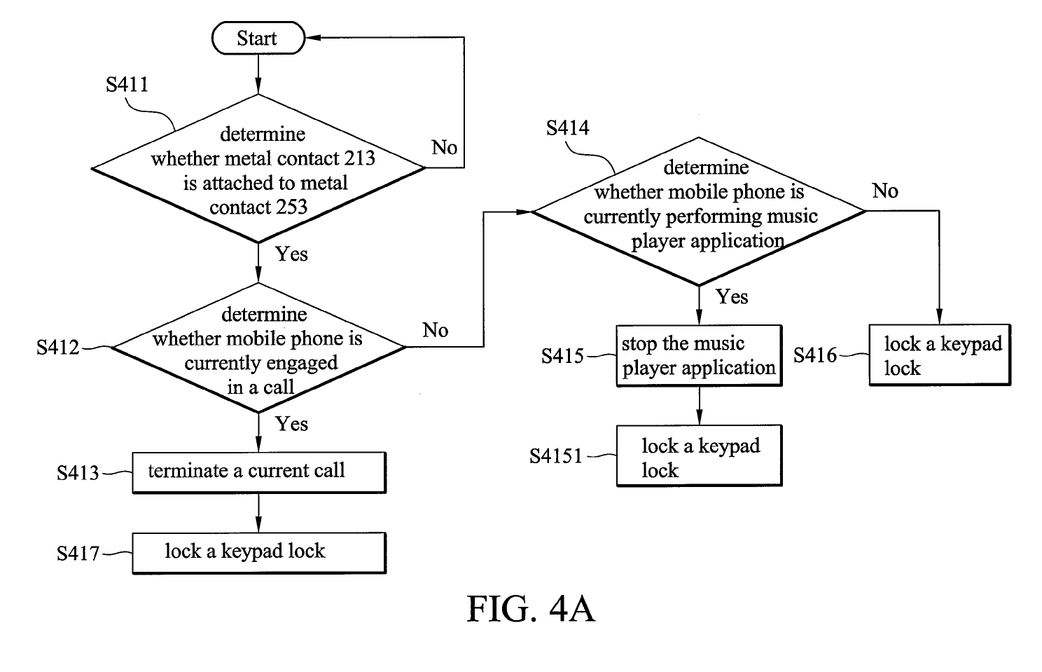

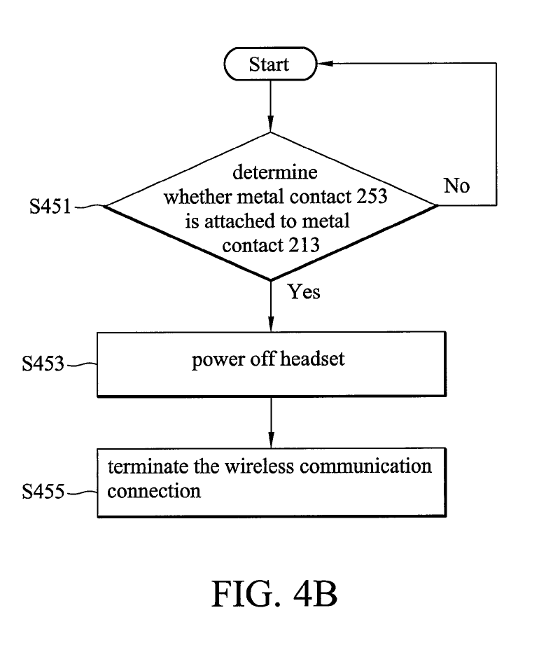

Using FIG. 4A as an example, operations of mobile phone 21 are illustrated when detecting that wireless headset 25 is put back to its original position. When the wireless headset 25 is put back to its original position, metal contact 213 is attached to metal contact 253. In step S411, it is determined whether metal contact 213 is attached to metal contact 253, and if so, the method proceeds to step S412, otherwise the method returns to the beginning. In step S412, it is determined whether mobile phone 21 is currently engaged in a call, and if so, the method proceeds to step S413, otherwise the method proceeds to step S414. In step S413, a current call is terminated. In step S414, it is determined whether mobile phone 21 is currently performing the music player application, and if so, the method proceeds to step S415, otherwise the method proceeds to step S416. In step S415, the music player application is stopped. In step S4151, a keypad lock is locked. In step S417, a keypad lock is locked immediately after the current call is terminated. In step S416, a keypad lock is locked.

Using FIG. 4B as an example, operations of wireless headset 25 are illustrated, when detecting that wireless headset 25 is put back to its original position. When the wireless headset 25 is put back to its original position, metal contact 213 is attached to metal contact 253. In step S451, it is determined whether metal contact 253 is attached to metal contact 213, and if so, the method proceeds to step S453, otherwise the method returns to the beginning. In step S453, headset 25 is powered off. In step S455, the wireless communication connection between mobile phone 21 and wireless headset 35 is terminated.

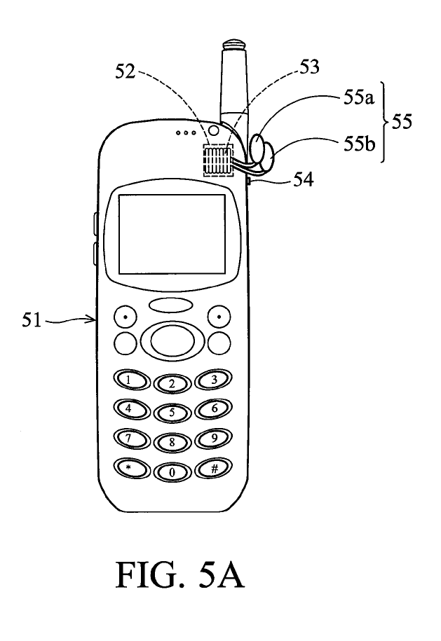

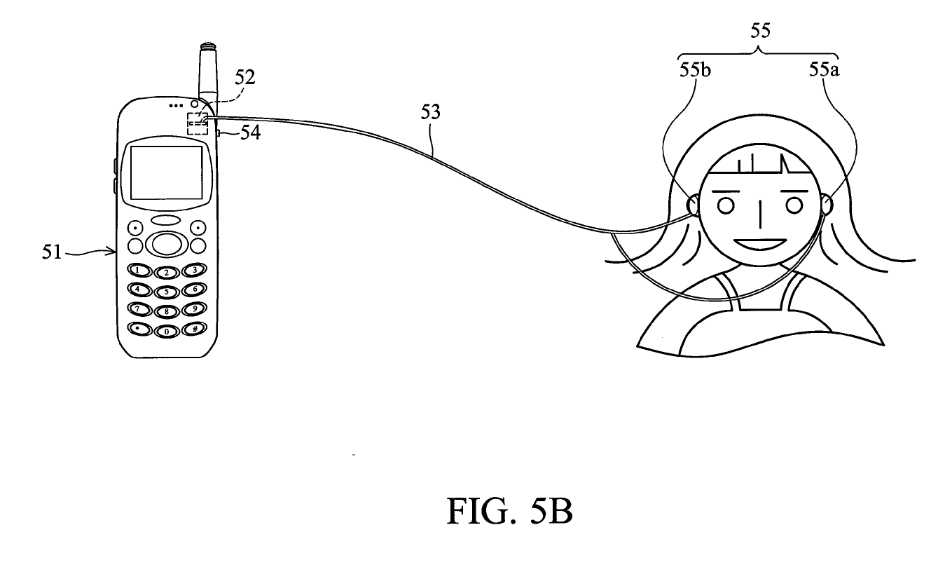

FIGS. 5A and 5B illustrate an embodiment of a mobile phone employing a wired headset. Using FIG. 5B as an example, a mobile phone 51 is connected to a headset 55 (comprising earbuds 55a and 55b) via a wire 53. The headset 55 is normally detachable from mobile phone 51, using a jack plug (not shown). Mobile phone 51 comprises a wire coiling unit 52 used for coiling up wire 53 when an actuator 54 is activated. When wire 53 is coiled into or drawn out from mobile phone 51, preset operations are triggered automatically.

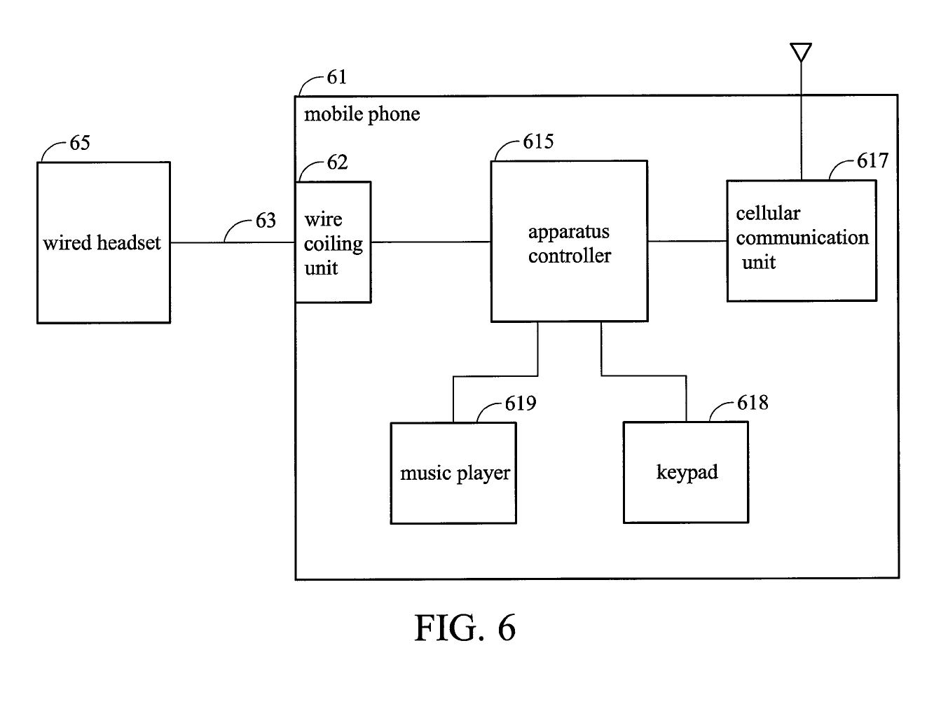

FIG. 6 shows a schematic view of an embodiment of a mobile phone and a wired headset attached thereto. A mobile phone 61 is connected to a wired headset 65 via a wire 63. The mobile phone 61 comprises a wire coiling unit 62, an apparatus controller 615, an actuator 64, cellular communication unit 617, music player 619, and keypad 618. The wire coiling unit 62 used for coiling up the wire 63 when actuator 64 is activated. The actuator 64 may be a push button. The cellular communication unit 617 is used for cellular network communication. The apparatus controller 615 is used for controlling operations of the telecommunication apparatus, the mobile phone 61, according to the status of the wire coiling unit 62. When the coiled wire is drawn out, the apparatus controller 615 can activate a preset action of the mobile phone 61 according to the status thereof. For example, apparatus controller 615 controls operation of the cellular communication unit 617 and music player 619, keypad 618, and other functional units equipped in mobile phone 61.

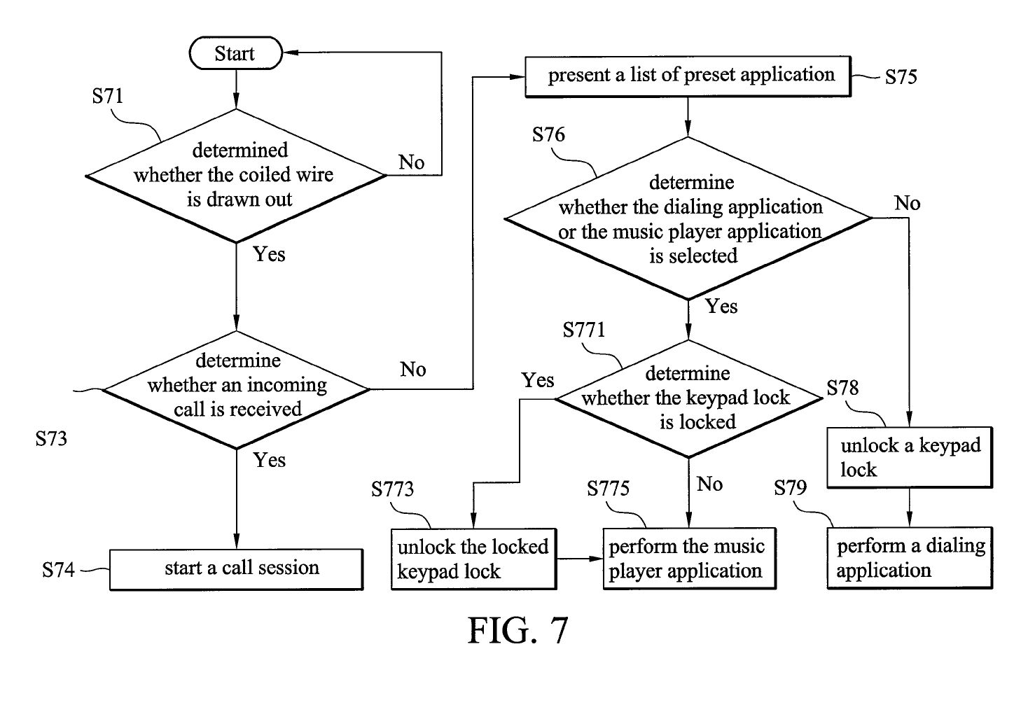

Operations of mobile phone 61 can be controlled according to the status of the wire coiling unit 62. FIG. 7 illustrates operations of mobile phone 61 when detecting that the coiled wire is drawn out. In step S71, it is determined whether the coiled wire is drawn out, and if so, the method proceeds to step S73, otherwise the method returns to the beginning. In step S73, it is determined whether an incoming call is received, and if so, the method proceeds to step S74, otherwise the method proceeds to step S75. In step S74, a call session is initiated, the cellular network communication connection being established, audio signals related to the incoming call being transferred to the headset 65 via the wire 63, and the mobile phone 61 is engaged in the call. In step S75, a list of preset applications is presented for selection. Here, a list comprising a dialing application and a music player application is presented. In step S76, it is determined whether the dialing application or the music player application is selected. If the dialing application is selected, the method proceeds to step S78, if the music player application is selected, the method proceeds to step S771. In step S771, it is determined whether the keypad lock is locked, and if so, the method proceeds to step S773, otherwise the method proceeds to step S775. In step S773, the locked keypad lock is unlocked. In step S775, the music player application is performed according to instructions input by a user. In step S78, a keypad lock, if any, is unlocked. In step S79, a dialing application is performed according to instructions input by a user.

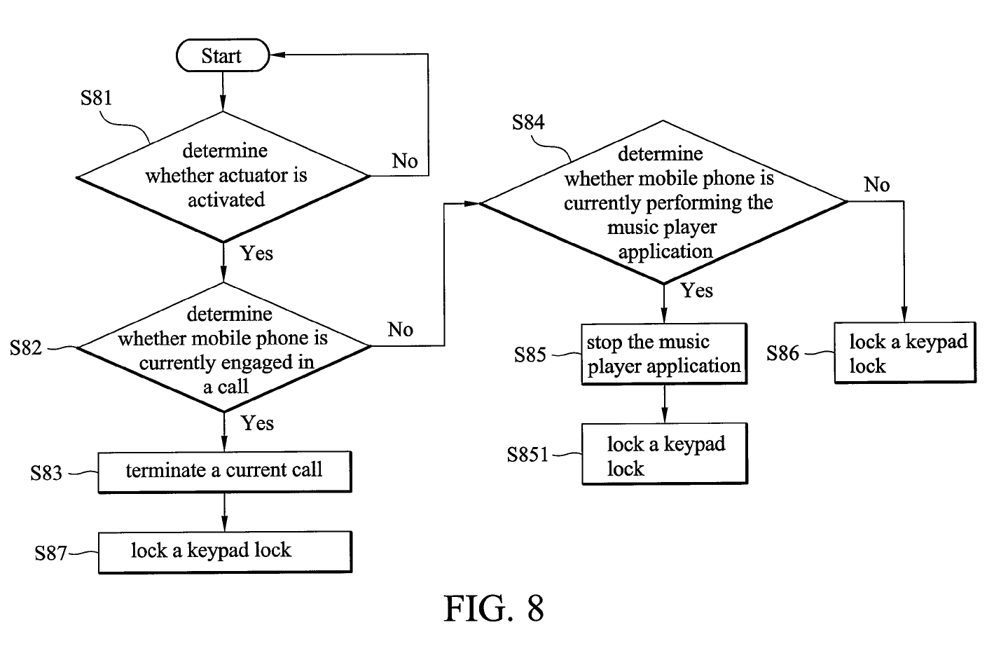

FIG. 8 illustrates operations of mobile phone 61 when wired headset is put back to its original position. When the wired headset is put back to its original position, actuator 64 is activated for coiling up wire 63. In step S81, it is determined whether actuator 64 is activated for coiling up wire 63, and if so, the method proceeds to step S82, otherwise the method returns to the beginning. In step S82, it is determined whether mobile phone 61 is currently engaged in a call, and if so, the method proceeds to step S83, otherwise the method proceeds to step S84. In step S83, a current call is terminated. In step S84, it is determined whether mobile phone 61 is currently performing the music player application, and if so, the method proceeds to step S85, otherwise the method proceeds to step S86. In step S85, the music player application is stopped. In step S851, a keypad lock is locked. In step S87, a keypad lock is locked immediately after the current call is terminated. In step S86, a keypad lock is locked.

While the invention has been described by way of example and in terms of several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A telecommunication system, comprising:
an audio accessory comprising:
an accessory interface; and
an accessory controller controlling operation of the audio accessory according to the connection status of the accessory interface; and
a telecommunication apparatus, comprising:
an apparatus interface for physically connecting to the accessory interface of the audio accessory; and
an apparatus controller controlling operation of the telecommunication apparatus according to connection status of the apparatus interface.

2. The telecommunication system of claim 1, wherein the audio accessory is a headset.

3. The telecommunication system of claim 1, wherein both the accessory interface and the apparatus interface comprise a metal contact, respectively, for direct electric connection.

4. The telecommunication system of claim 3, further comprising a detecting circuit to detect connection status of the metal contacts of the accessory interface and the apparatus interface.

5. The telecommunication system of claim 3, wherein the audio accessory further comprises an accessory battery, and the telecommunication apparatus further comprises an apparatus battery, wherein the accessory battery receives or supplies electric current from and to the apparatus battery when electrically connected to the telecommunication apparatus via the metal contact.

6. The telecommunication system of claim 5, wherein the audio accessory further comprises an accessory power connector, and the telecommunication apparatus further comprises an apparatus power connector, the accessory battery and apparatus battery are recharged when the audio accessory is electrically connected to the telecommunication apparatus via the metal contact and when the telecommunication apparatus and/or the audio accessory is electrically connected to an external electrical power source for recharging.

7. The telecommunication system of claim 3, wherein the audio accessory and the telecommunication apparatus communicate and transfers data via the metal contact.

8. The telecommunication system of claim 1, wherein the audio accessory and the telecommunication apparatus further comprise wireless communication means, respectively, for establishing a wireless communication connection therebetween.

9. The telecommunication system of claim 8, wherein when detecting the accessory interface detached from the apparatus interface, the accessory controller will turn on the audio accessory and activates the means for communication equipped in the audio accessory to establish the wireless communication connection with the apparatus, when detect the accessory interface is detached from the apparatus interface, the apparatus controller will activates the means for communication equipped in the apparatus to establish the wireless communication connection with the audio accessory.

10. The telecommunication system of claim 9, wherein when the telecommunication apparatus is receiving a call, the apparatus controller starts a call session, and transfers audio signals to the audio accessory via the established wireless communication connection.

11. The telecommunication system of claim 9, wherein the apparatus controller triggers a music playing function.

12. The telecommunication system of claim 9, wherein the apparatus controller unlocks a keypad lock of the telecommunication apparatus.

13. The telecommunication system of claim 1, wherein the accessory controller turns off the audio accessory when detecting the accessory interface attached to the apparatus interface.

14. The telecommunication system of claim 13, wherein when detecting the accessory interface attached to the apparatus interface, the apparatus controller, when the telecommunication apparatus is currently engaged in a call, ends the call.

15. The telecommunication system of claim 13, wherein when detecting the accessory interface attached to the apparatus interface, the apparatus controller, when the telecommunication apparatus is currently operating a music playing function, stops the music playing function.

16. The telecommunication system of claim 13, wherein when detecting the accessory interface attached to the apparatus interface, the apparatus controller, when the telecommunication apparatus is currently idle, locks a keypad lock of the telecommunication apparatus.

17. The telecommunication system of claim 1, wherein the accessory interface and the apparatus interface comprises a magnetic induction device, respectively, and the detachment and attachment of the accessory and apparatus interfaces can be detected through magnetic induction between the magnetic induction devices.

18. The telecommunication system of claim 1, wherein the accessory interface and the apparatus interface comprises a tenon-mortise structure, respectively, and the detachment and attachment of the accessory and apparatus interfaces can be detected through mechanical joining between the tenon-mortise structures.

19. The telecommunication system of claim 1, wherein the accessory interface and the apparatus interface connects through a wire for wired communication connection between the audio accessory and the telecommunication apparatus.

20. The telecommunication system of claim 19, wherein the telecommunication apparatus further comprises an actuator and a wire coiling unit, which coils up the wire when the actuator is activated.

21. The telecommunication system of claim 20, wherein when the telecommunication apparatus is receiving a call and the coiled wire is drawn out, the apparatus controller starts a call session, and transfers audio signals to the audio accessory via the wire.

22. The telecommunication system of claim 20, wherein when the coiled wire is drawn out, the apparatus controller, triggers a music playing function of the telecommunication apparatus.

23. The telecommunication system of claim 20, wherein when the coiled wire is drawn cut, the apparatus controller unlocks a keypad lock of the telecommunication apparatus.

24. The telecommunication system of claim 20, wherein when the telecommunication apparatus is currently engaged in a call and the actuator is activated for coiling up the wire, the apparatus controller ends the call.

25. The telecommunication system of claim 20, wherein the apparatus controller, when the telecommunication apparatus is operating a music playing function and the actuator is activated for coiling up the wire, stops the music playing function.

26. The telecommunication system of claim 20, wherein the apparatus controller, when the actuator is activated for coiling up the wire, locks a keypad lock of the telecommunication apparatus.

27. The telecommunication system of claim 1, wherein the telecommunication apparatus further comprises a telecommunication network communication unit for establishing a communication connection between the telecommunication apparatus and a base station.

28. A method of controlling a telecommunication system, wherein the telecommunication system comprises an audio accessory and a telecommunication apparatus, the method comprising:
establishing a physically connection between the audio accessory and the telecommunication apparatus;
detecting whether the status of the connection is changed;
directing operation of the audio accessory and/or the telecommunication apparatus upon the change of the connection status.

29. The method of claim 28, further establishing a direct connection by a pair of metal contacts equipped in the audio accessory and the telecommunication apparatus, respectively.

30. The method of claim 29, further detecting connection status of the pair of metal contacts of the audio accessory and the telecommunication apparatus.

31. The method of claim 29, further providing an accessory battery in the audio accessory, providing an apparatus battery in the telecommunication apparatus, wherein the accessory battery receives or supplies electric current from and to the apparatus battery when electrically connected to the telecommunication apparatus via the metal contacts.

32. The method of claim 31, further providing an accessory power connector in the audio accessory, and providing an apparatus power connector in the telecommunication apparatus, and recharging the accessory battery and apparatus battery when the audio accessory is electrically connected to the telecommunication apparatus via the metal contacts and when the telecommunication apparatus and/or the audio accessory is electrically connected to an external electrical power source for recharging.

33. The method of claim 28, further establishing a wireless communication connection between the audio accessory and the telecommunication apparatus.

34. The method of claim 33, further turning on the audio accessory and establishing the wireless communication connection with the apparatus when detecting the physical connection between the audio accessory and the telecommunication apparatus is broken.

35. The method of claim 34, when the telecommunication apparatus is receiving a call, further starting a call session, and transferring audio signals to the audio accessory via the established wireless communication connection.

36. The method of claim 34, further triggerring a music playing function in the telecommunication apparatus.

37. The method of claim 34, further unlocking a keypad lock of the telecommunication apparatus.

38. The method of claim 28, further turning off the audio accessory upon establishing of the physical connection.

39. The method of claim 38, when the telecommunication apparatus is currently engaged in a call, further ending the call upon establishing of the physical connection.

40. The method of claim 38, when the telecommunication apparatus is currently operating a music playing function, further stopping the music playing function upon establishing of the physical connection.

41. The method of claim 38, when the telecommunication apparatus is currently idle, further locking a keypad lock of the telecommunication apparatus upon establishing of the physical connection.

42. The method of claim 28, further providing a magnetic induction device in the telecommunication system, and detecting the connection status change through magnetic induction between the magnetic induction devices.

43. The method of claim 28, further providing a tenon-mortise structure in the telecommunication system, and detecting the connection status change through mechanical joining between the tenon-mortise structures.

44. The method of claim 28, establishing a wired communication connection between the audio accessory and the telecommunication apparatus.

45. The method of claim 44, further providing an actuator and a wire coiling unit in the telecommunication apparatus, and coiling up the wire when the actuator is activated.

46. The method of claim 45, when the telecommunication apparatus is receiving a call, further starting a call session in the telecommunication apparatus, and transferring audio signals from the telecommunication apparatus to the audio accessory via the wire upon drawing out of the coiled wire.

47. The method of claim 45, further triggering a music playing function of the telecommunication apparatus upon drawing out of the coiled wire.

48. The method of claim 45, unlocking a keypad lock of the telecommunication apparatus upon drawing out of the coiled wire.

49. The method of claim 45, when the telecommunication apparatus is currently engaged in a call, further ending the call upon coiling up of the wire.

50. The method of claim 45, when the telecommunication apparatus is operating a music playing function, further stopping the music playing function upon coiling up the wire.

51. The method of claim 45, further locking a keypad lock of the telecommunication apparatus upon coiling up the wire.
